(19) United States
(12) Patent Application Publication
(10) Pub. No.: US 2008/0235762 A1
(43) Pub. Date: Sep. 25, 2008

(54) Pressure Map Based Fingerprint Authentication Method and System

(75) Inventor: Srinivas Venkata Rama Gutta, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., Eindhoven (NL)

(21) Appl. No.: 10/598,890

(22) PCT Filed: Mar. 14, 2005
(86) PCT No.: PCT/IB05/50894

§ 371 Date: Sep. 14, 2006

Related U.S. Application Data
(60) Provisional application No. 60/553,752, filed on Mar. 16, 2004.

(51) Int. Cl. H04L 9/32

(52) U.S. Cl. 726/2

(57) ABSTRACT

A fingerprint system (80) implements a fingerprint authentication method (20, 60) for a user fingerprint image (UFI) based on a plurality of control fingerprint images (CFI). The method involves a transformation of each control fingerprint image (CFI) into a transformed control fingerprint image (TCFI) as a function of a pressure map (PM) associated with the user fingerprint image (UFI), a matching of each transformed control fingerprint image (TCFI) to the user fingerprint image (UF 1), and an authentication of the transformed control fingerprint image (TCFI) having a best match with the user fingerprint image (UFI) as an identified fingerprint image (IFI).

The present invention generally relates to fingerprint identification methods and systems. The present invention specifically relates to fingerprint identification systems implementing a method involving the use of a pressure sensor array that measures pressures to differentiate between ridges and valleys of a fingerprint.

Fingerprint systems as known in the art employ fingerprint enrollment modules for enrolling enrollees and their fingerprints into a system database, and fingerprint authentication modules for authenticating an identity of a particular user of the system from a fingerprint stored on the system database. These fingerprint systems work well when a user places his or her finger on a fingerprint sensor during an authentication of the user in the same way the user placed his or her finger on the fingerprint sensor during an enrollment of the user. Conversely, a performance of the fingerprint system is drastically reduced if the user does not place his or her finger on the fingerprint sensor during an authentication of the user in the same way the user placed his or her finger on the fingerprint sensor during an enrollment of the user. This is particularly true for pressure sensors that measure pressures to differentiate ridge and valleys of a fingerprint, such as, for example, the pressure sensor disclosed in U.S. Pat. No. 6,578,436 B1 entitled “Method and Apparatus for Pressure Sensing” and issued Jun. 17, 2003, which is hereby incorporated by reference herein in its entirety.

The present invention provides a new and unique pressure based fingerprint identification method and system for minimizing, if not eliminating, any performance reduction due to a user placing his or her finger on the fingerprint sensor during an authentication of the user in a different way than the user placed his or her finger on the fingerprint sensor during an enrollment of the user.

One form of the present invention is a fingerprint authentication method involving a transformation of each control fingerprint image into a transformed control fingerprint image as a function of a pressure map associated with a user fingerprint image, a matching of each transformed control fingerprint image to the user fingerprint image, and an authentication of the transformed control fingerprint image having a best match with the user fingerprint image as an identified fingerprint image.

A second form of the present invention is a fingerprint identification device employing means for transforming each control fingerprint image into a transformed control fingerprint image as a function of a pressure map associated with a user fingerprint image; means for matching each transformed control fingerprint image to the user fingerprint image; and means for authenticating the transformed control fingerprint image having a best match with the user fingerprint image as an identified fingerprint image.

A third form of the present invention is a fingerprint identification system a database operable to store a plurality of control fingerprint images. The system employs a fingerprint authentication module operable to retrieve the control fingerprint images to thereby authenticate one of the control fingerprint images with a user fingerprint image. To this end, the fingerprint authentication module is further operable to transform each control fingerprint image into a transformed control fingerprint image as a function of a pressure map associated with the user fingerprint image, to match each transformed control fingerprint image to the user fingerprint image, and to authenticate the transformed control fingerprint image having a best match with the user fingerprint image as an identified fingerprint image.

The term “module” is defined herein as a structural configuration of processing hardware and/or programmed software.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

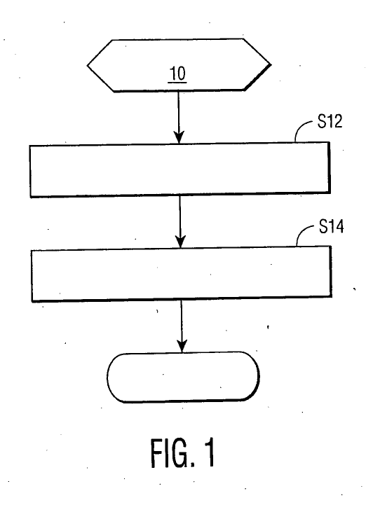

FIG. 1 illustrates a flowchart representative of one embodiment of a fingerprint enrollment method in accordance with the present invention;

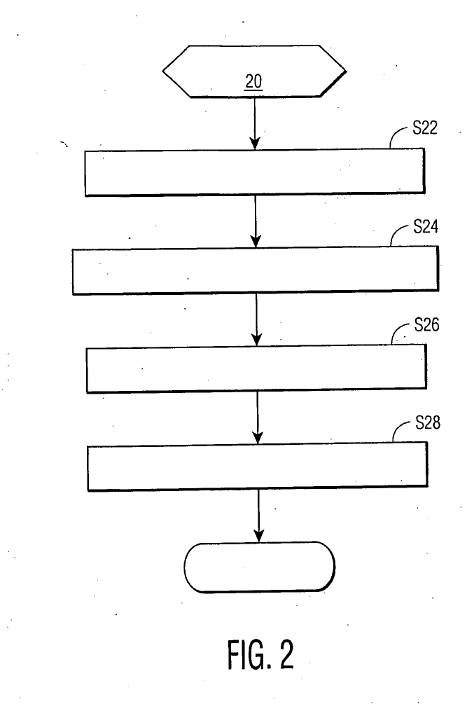

FIG. 2 illustrates a flowchart representative of one embodiment of a fingerprint authentication method in accordance with the present invention;

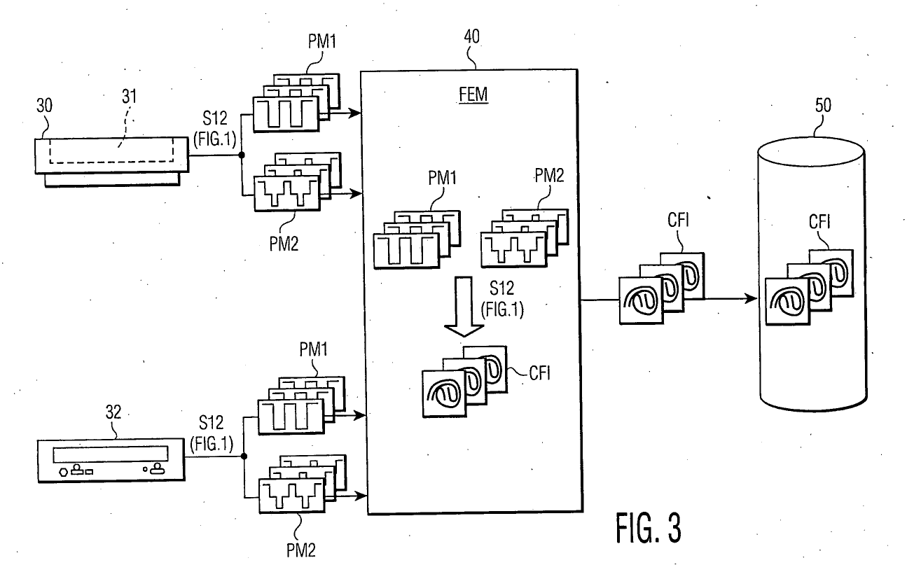

FIG. 3 illustrates one embodiment of a fingerprint enrollment system in accordance with the present invention for implementing the fingerprint enrollment method illustrated in FIG. 1;

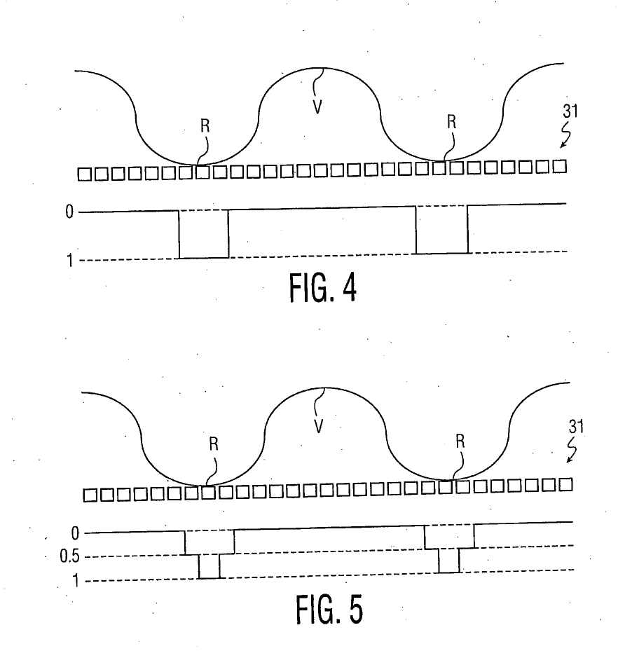

FIG. 4 illustrates a first exemplary pulse response from a first embodiment of a pressure sensor in accordance with the present invention;

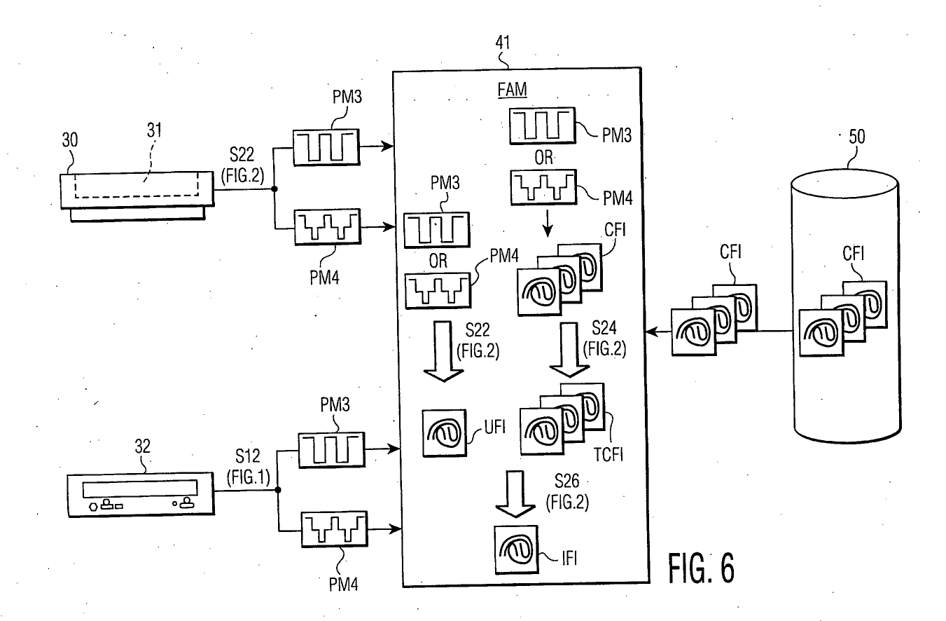

FIG. 5 illustrates a second exemplary pulse response from a second embodiment of a pressure sensor in accordance with the present invention;

FIG. 6 illustrates one embodiment of a fingerprint authentication system in accordance with the present invention for implementing the fingerprint authentication method illustrated in FIG. 2;

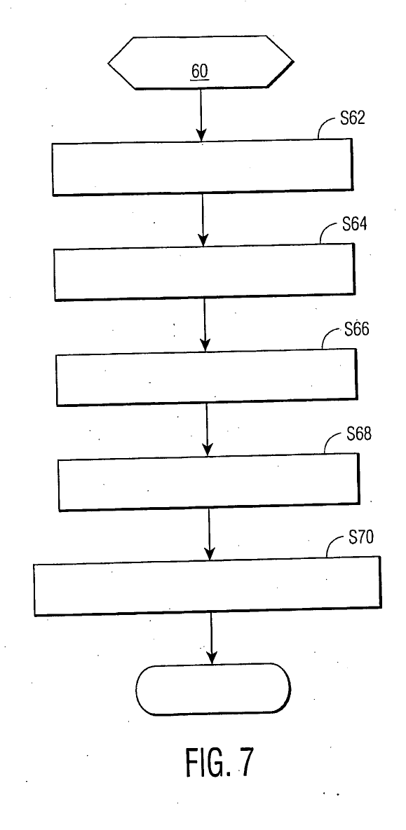

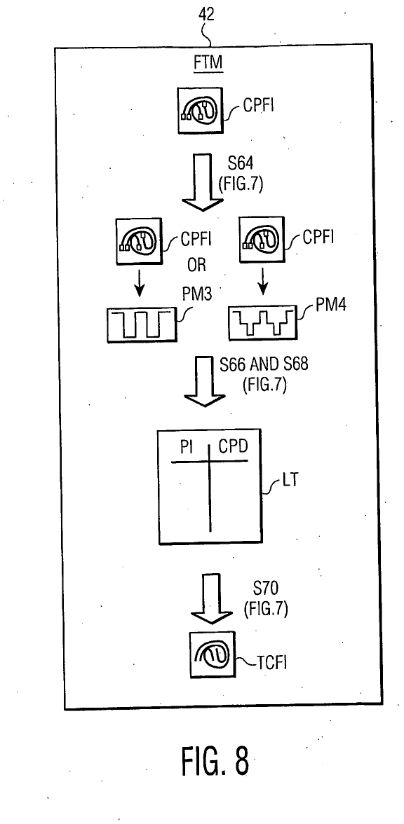

FIG. 7 illustrates a flowchart representative of one embodiment of a fingerprint transformation method in accordance with the present invention;

FIG. 8 illustrates one embodiment of a fingerprint transformation module in accordance with the present invention for implementing the fingerprint transformation method illustrated in FIG. 7; and

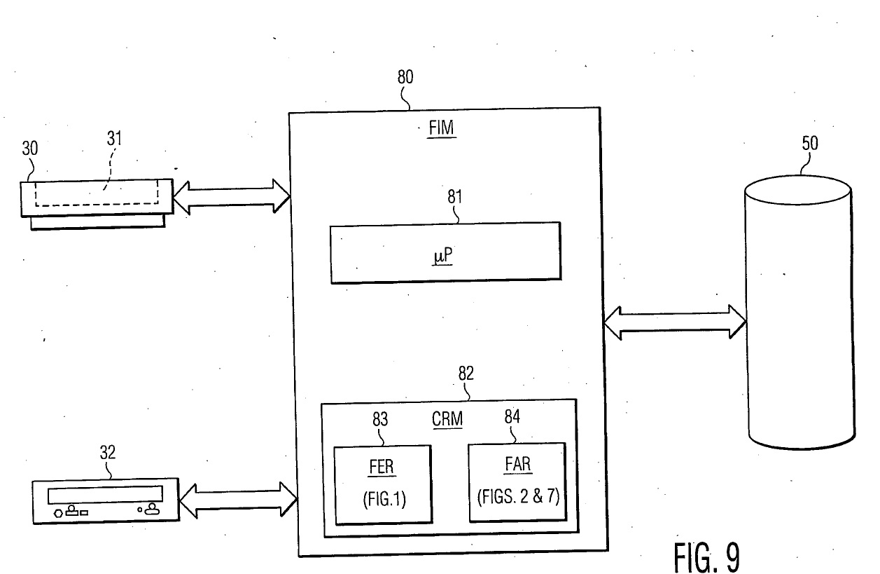

FIG. 9 illustrates one embodiment of a fingerprint identification module in accordance with the present invention for implementing the fingerprint enrollment method, the fingerprint authentication method, and the fingerprint transformation method illustrated in FIGS. 1, 2 and 7, respectively.

A flowchart 10 illustrated in FIG. 1 is representative of a fingerprint enrollment method of the present invention. During a stage S12 of flowchart 10, a control fingerprint image for an enrollee is acquired. In practice, the type of technique employed for acquiring the control fingerprint image of the enrollee is dependent upon a commercial implementation of the present invention, and is therefore without limit.

In one exemplary embodiment, a conventional pressure sensor 30 having a sensory array 31 (e.g., a pressure sensor disclosed in U.S. Pat. No. 6,578,436 B1) is employed to acquire a conventional pressure map PMI of the enrollee as exemplary illustrated in FIG. 3 that is based on conventional pulse responses as exemplary illustrated in FIG. 4 for differentiating between ridges R via a digital “1” and valleys V via a digital “0”. A fingerprint enrollment module (“FEM”) 40 as illustrated in FIG. 3 is thereafter employed to conventionally derive a control fingerprint image CFI from pressure map PMI of the enrollee.

In a second exemplary embodiment, pressure sensor 30 is employed to acquire a pressure map PM2 of the enrollee as illustrated in FIG. 3 that is based on pulse responses as exemplary illustrated in FIG. 4 for differentiating between peaks of ridges R via a digital “1”, non-peaks of ridges R via a digital “0.5”, and valleys V via a digital “0”. Those having ordinary skill in the art will appreciate a structural modification of the pressure sensor disclosed in U.S. Pat. No. 6,578,436 B1 that would enable an acquisition of pressure map PM2 and the like. Fingerprint enrollment module 40 is thereafter employed to conventionally derive a control fingerprint image CFI from pressure map PM2 of the enrollee.

In a third exemplary embodiment, a digital input device of any type is employed to acquire a pre-generated pressure map PM1 or a pre-generated pressure map PM2, such as, for example, a disk drive 32 as illustrated in FIG. 3, a card reader and a scanner. Fingerprint enrollment module 40 is thereafter employed to conventionally derive a control fingerprint image CFI from the pre-generated pressure map PM1 or the pre-generated pressure map PM2 of the enrollee.

During a stage S14 of flowchart 10, the control fingerprint image is stored. In practice, the type of technique employed for storing the control fingerprint image is dependent upon a commercial implementation of the present invention, and is therefore without limit. In one exemplary embodiment, fingerprint enrollment module 40 manages a storing of a file for control fingerprint image CFI into a database 50 as exemplary illustrated in FIG. 3 where the file includes a name of the enrollee, one or more conventional templates constituting control fingerprint image CFI, and any other information necessary for future authentications involving the control fingerprint image CFI.

Flowchart 10 is terminated upon completion of stage S14, and is re-implemented upon a new enrollment. For purposes of facilitating an understanding of the fingerprint authentication method of the present invention, the subsequent description herein of FIGS. 2, and 6-8 are based on the acquisition of the three (3) pressure maps of any type from three (3) enrollees and the storage of three (3) control fingerprint images for the three (3) enrollees. However, those having ordinary skill in the art will appreciate the applicability of the present invention to any number of enrollees. Additionally, those having ordinary skill in the art will appreciate that the maximum number of enrollees is dependent upon the size of the database or databases for storing the control fingerprint images of all enrollees.

A flowchart 20 illustrated in FIG. 2 is representative of a fingerprint authentication method of the present invention. During a stage S22 of flowchart 20, a user fingerprint image is acquired. In practice, the type of technique employed for acquiring the user fingerprint image is dependent upon a commercial implementation of the present invention, and is therefore without limit.

In one exemplary embodiment, pressure sensor 30 or digital input device 32 as illustrated in FIG. 6 are employed to acquire a pressure map PM3 or a pressure map PM4, and a fingerprint authentication module (“FAM”) 41 as illustrated in FIG. 6 is employed to conventionally derive a user fingerprint image UFI as illustrated in FIG. 3 from pressure map PM3 or pressure map PM4. As would be appreciated by those having ordinary skill in the art, user fingerprint image UFI constitutes a black and white fingerprint image when derived from pressure map PM3, and user fingerprint image UFI constitutes a grayscale fingerprint image when derived from pressure map PM4.

During a stage S24 of flowchart 20, two or more of the enrolled control fingerprint images are transformed as function of the pressure map associated with the user fingerprint image. In practice, the type of technique employed for transforming two or more of the enrolled control fingerprint images are transformed as a function of the pressure map associated with the user fingerprint image is dependent upon a commercial implementation of the present invention, and is therefore without limit.

In one exemplary embodiment, fingerprint authentication module 41 as illustrated in FIG. 6 is employed to apply pressure map PM3 or pressure map PM4 against three (3) control fingerprint images CFI retrieved from database 50 to thereby yield three (3) transformed control fingerprint images TCFI. In practice, the method implemented in applying pressure map PM3 or map PMS against the three (3) control fingerprint images CFI is dependent upon a commercial implementation of the present invention, and is therefore without limit. In one exemplary embodiment, a flowchart 60 as illustrated in FIG. 7 is implemented during stage S24 of flowchart 20.

During a stage S62 of flowchart 60, control points (e.g., cores, deltas, ridge endings, ridge bifurcations, etc.) within a control fingerprint image are conventionally computed. In practice, the type of technique employed for computing control points within a control fingerprint image is dependent upon a commercial implementation of the present invention, and is therefore without limit. In one exemplary embodiment, a fingerprint transformation module (“FTM”) 42 as illustrated in FIG. 8 is employed by fingerprint authentication module 41 (FIG. 6) to compute control points within a control fingerprint image CFI (FIG. 6) to thereby yield a control point fingerprint image CPFI as exemplary illustrated in FIG. 8. These control point computations by fingerprint transformation module 42 are accomplished in accordance with a publication by Anil K. Jain and Sharath Pankanti entitled “Fingerprint Matching and Classifications”, in Handbook of Image Processing, A. Bovik (ed.), pp. 821-835, Academic Press, 2000, which is hereby incorporated by reference in its entirety.

During a stage S64 of flowchart 60, the control points of the control point fingerprint image are conventionally registered and superimposed on a pressure map associated with the user fingerprint image. In practice, the type of technique employed for superimposing the control points of the control point image on the pressure map associated with the user is dependent upon a commercial implementation of the present invention, and is therefore without limit.

In one-exemplary embodiment, fingerprint transformation module 42 as illustrated in FIG. 8 is employed to conventionally register and superimpose the control points within control point fingerprint image CPFI on pressure map PM3 or pressure map PM4, or vice-versa as exemplary illustrated in FIG. 8. This registration and superimposition of control points within control point fingerprint image CPFI on pressure map PM3 or pressure map PM4, or vice-versa can be accomplished in accordance with a publication by Anil K. Jain, L. Hong, Sharath Pankanti and R. Bolle entitled “On-Line Identity-Authentication System Using Fingerprints”, Proceedings of IEEE (Special Issue of Biometrics), vol. 85, pp. 1365-1388, September 1997, which is hereby incorporated by reference in its entirety. Additionally, this registration and superimposition of control points within control point fingerprint image CPFI on pressure map PM3 or pressure map PM4, or vice-versa can be accomplished within pre-defined tolerance parameters and/or filtering parameters designed to facilitate a reasonable superimposition the control points within control point fingerprint image CPFI on pressure map PM3 or pressure map PM4, or vice-versa. Any pre-defined tolerance parameters and filtering parameters are design driven based on the commercial implementation of the present invention, and are therefore without limit.

During a stage S66 of flowchart 60, an intensity of the pressure map pixels and their direction around a neighborhood of the control points is conventionally computed. In practice, the type of technique employed for computing the intensity of the pressure map pixels and their direction around a neighborhood of the control points is dependent upon a commercial implementation of the present invention, and is therefore without limit. In one exemplary embodiment, fingerprint transformation module 42 as illustrated in FIG. 8, is employed to conventionally compute the intensity of the pressure map pixels and their direction around a neighborhood of the control points.

During a stage S68 of flowchart 60, the intensity of the pressure map pixels as computed during stage S66 are mapped to a look-up table correlating the pixel intensities to distances the control points need to be moved to thereby transform the control fingerprint image as a function of the pressure map intensities in an attempt to match, to the greatest extent possible, the control fingerprint image to the user fingerprint image. In practice, the type of technique employed for mapping the pixel intensities of the pressure map pixels is dependent upon a commercial implementation of the present invention, and is therefore without limit. In one exemplary embodiment, fingerprint transformation module 42 as illustrated in FIG. 8 is employed to generate a lookup table LT as illustrated in FIG. 8 for mapping pixel intensities PI and corresponding control point distances CPD.

During a stage S70 of flowchart 60, the control fingerprint image is conventionally warped as a function of the mapped pixel intensities to thereby yield a transformed control fingerprint image. In practice, the type of technique employed for warping the control fingerprint image as a function of the mapped pixel intensities is dependent upon a commercial implementation of the present invention, and is therefore without limit. In one exemplary embodiment, fingerprint transformation module 42 as illustrated in FIG. 8 is employed to conventionally warp the control fingerprint image CFI (FIG. 6) as a function of the mapped pixel intensities to thereby yield transformed control fingerprint image TCFI as a representation of an attempt to match, to the greatest extent possible, the control fingerprint image CFI to the user fingerprint image UFI.

Flowchart 60 terminates after stage S70, and is repeated for each control fingerprint image to be transformed in accordance with flowchart 60. A stage S24 of flowchart 20 is implemented upon obtaining all of the necessary transformed control fingerprint images (e.g., three (3) transformed control fingerprint images as illustrated in FIG. 6).

Referring again to FIG. 2, the user fingerprint image is matched to each transformed control fingerprint image during a stage S24. In practice, the type of technique employed for matching the user fingerprint image to each transformed control fingerprint image is dependent upon a commercial implementation of the present invention, and is therefore without limit.

In one exemplary embodiment, fingerprint authentication module 41 as illustrated in FIG. 6 is employed to conventionally match user fingerprint image UFI to all three (3) transformed control fingerprint image TCFI based on U.S. Pat. No. 6,185,318 B1 entitled “System And Method For Matching (Fingerprint) Images An Aligned Representation” and issued Feb. 6, 2001, which is hereby incorporated by reference in its entirety. The result is a matching score, normalized or not, for each transformed control fingerprint image TCFI as matched to user fingerprint image UFI.

During a stage S28 of flowchart 20, an identified fingerprint image is selected based on the user fingerprint image and transformed control fingerprint image pair having the best match. In practice, the type of technique employed for choosing the user fingerprint image and transformed control fingerprint image pair having the best match is dependent upon a commercial implementation of the present invention, and is therefore without limit.

In one exemplary embodiment, fingerprint authentication module 41 as illustrated in FIG. 6 is employed to chose the transformed control fingerprint image TCFI from transformed control fingerprint image TCFI having the highest matching score, normalized or not, in accordance with U.S. Pat. No. 6,185,318 B1. Accordingly, the control fingerprint image CFI corresponding to the transformed control fingerprint image TCFI having the highest matching score is selected by fingerprint authentication module 41 to be the identified fingerprint image IFI and the user is identified from the user file stored in database 50 that corresponds to this control fingerprint image CFI.

Flowchart 20 is terminated upon completion of stage S28, and is re-implemented upon a need to authenticate a new user.

While the implementations of flowchart 10 (FIG. 1), flowchart 20 (FIG. 2) and flowchart 60 (FIG. 7) were described herein in a sequential execution of stages, the implementation order of the stages in practice is without limit.

Those of ordinary skill in the art will appreciate that, in practice, a structural implementation of module 40 (FIG. 3), module 41 (FIG. 6 and module 42 (FIG. 8) will vary depending on the specific implementation of a device or system embodying the present invention. Thus, the variety of actual hardware platforms and software environments for structurally implementing modules 40-42 is without limit.

In one exemplary embodiment, a fingerprint identification module (“FIM”) 80 of the present invention as illustrated in FIG. 9 employs a conventional processor (“μP”) 81 of any type (e.g., a digital signal processor) encompassing the processing hardware, in part or in whole, of modules 4042. Fingerprint identification module 80 also employs a conventional computer readable medium 82 of any type (e.g., a hard drive, etc.) for storing computer instructions programmed, conventional or otherwise, in a fingerprint identification routine (“FER”) 83 encompassing flowchart 10 (FIG. 1), and for storing computer instructions programmed, conventional or otherwise, in a fingerprint identification routine (“FIR”) 84 encompassing flowchart 20 (FIG. 2) and flowchart 60 (FIG. 7). As such, processor 81 can be operated to execute a conventional operating system to control program execution of the computer instructions of routines 83 and 84, and to interface with pressure sensor 30, disk driver 32 and database 50 on a local or network basis.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A fingerprint authentication method (20) for a user fingerprint image (UFI) based on a plurality of control fingerprint images (CFI), the method comprising:
(S24) transforming each control fingerprint images (CFI) into a transformed control fingerprint image (TCFI) as a function of a pressure map (PM) associated with the user fingerprint image (UFI);
(S26) matching each transformed control fingerprint image (TCFI) to the user fingerprint image (UF1); and
(S28) authenticating a first transformed control fingerprint image (TCFI) having a best match with the user fingerprint image (UFI) as an identified fingerprint image (IFI).

2. The fingerprint authentication method (20) of claim 1, further comprising:
(S22) deriving the user fingerprint image (UFI) from the pressure map (PM), wherein the user fingerprint image (UFI) is a black and white fingerprint image.

3. The fingerprint authentication method (20) of claim 1, further comprising:
(S22) deriving the user-fingerprint image (UFI) from the pressure map (PM), wherein the user fingerprint image (UFI) is a grayscale fingerprint image.

4. The fingerprint authentication method (20) of claim 1, wherein (S24) transforming each two control fingerprint image (CFI) into a transformed control fingerprint image (TC1) as a function of the pressure map (PM) associated with the user fingerprint image (UFI) includes:
(S62) computing at least one control point within a first control fingerprint image (CFI) to yield a control point fingerprint image (CPFI);
(S64) superimposing the at least one control point onto the pressure map (PM); and
(S66) computing pixel intensities and directions around a neighborhood of the at least one control point from the pressure map.

5. The fingerprint identification method (20) of claim 4, wherein (S24) transforming each two control fingerprint image (CFI) into a transformed control fingerprint image (TC1) as a function of the pressure map (PM) associated with the user fingerprint image (UFI) further includes:
(S68) mapping the pixel intensities and corresponding control point distances for matching, to a greatest extent possible, the first control fingerprint image (CF1) into the user fingerprint image (UFI); and
(S70) warping the first control fingerprint image (CF1) based on the mapped pixel intensities and control point distances to thereby yield the first transformed control fingerprint image (TCFI).

6. The fingerprint authentication method (20) of claim 1, wherein (S24) transforming each two control fingerprint image (CFI) into a transformed control fingerprint image (TC1) as a function of the pressure map (PM) associated with the user fingerprint image (UFI) includes:
(S62) computing at least one control point within a first control fingerprint image (CFI) to yield a control point fingerprint image (CPFI);
(S64) superimposing the pressure map (PM) onto the at least one control point; and
(S66) computing pixel intensities and directions around a neighborhood of the at least one control point from the pressure map.

7. The fingerprint identification method (20) of claim 6, wherein (S24) transforming each two control fingerprint image (CFI) into a transformed control fingerprint image (TC1) as a function of the pressure map (PM) associated with the user fingerprint image (UFI) further includes:
(S68) mapping the pixel intensities and corresponding control point distances for matching, to a greatest extent possible, the first control fingerprint image (CF1) into the user fingerprint image (UFI); and
(S70) warping the first control fingerprint image (CF1) based on the mapped pixel intensities and control point distances to thereby yield the first transformed control fingerprint image (TCFI).

8. The fingerprint identification method (20) of claim 1, wherein (S26) matching each transformed control fingerprint image (TCFI) to the user fingerprint image (UF1) includes:
computing a matching score of each transformed control fingerprint image (TCFI) to the user fingerprint image (UF1).

9. The fingerprint identification method (20) of claim 1, wherein (S28) authenticating the first transformed control fingerprint image (TCFI) having the best match with the user fingerprint image (UFI) as an identified fingerprint image (IFI) includes:
selecting the first transformed control fingerprint image (TCFI) based on the first transformed control fingerprint image (TCFI) having a highest matching score among all of the matching scores.

10. A fingerprint authentication module (80) for a user fingerprint image (UFI) based on a plurality of control fingerprint images (CFI), comprising:
means (81-83) for transforming each control fingerprint images (CFI) into a transformed control fingerprint image (TCF1) as a function of a pressure map (PM) associated with the user fingerprint image (UFI);
means (81-83) for matching each transformed control fingerprint image (TCFI) to the user fingerprint image (UF1); and
means (81-83) for authenticating a first transformed control fingerprint image (TCFI) having a best match with the user fingerprint image (UFI) as an identified fingerprint image (IFI).

11. The fingerprint identification device (80) of claim 10, further comprising:
means (81-83) for deriving the user fingerprint image (UFI) from the pressure map (PM), wherein the user fingerprint image (UFI) is a black and white fingerprint image.

12. The fingerprint identification device (80) of claim 10, further comprising:
means (81-83) for deriving the user fingerprint image (UFI) from the pressure map (PM), wherein the user fingerprint image (UFI) is a grayscale fingerprint image.

13. A fingerprint authentication system, comprising:
a database (50) operable to store a plurality of control fingerprint images (CFI); and
a fingerprint module (41 and 80) operable to retrieve the plurality of control fingerprint images (CFI) from the database (50) to thereby authenticate one of the control fingerprint images (CFI) with a user fingerprint image (UFI),
wherein the fingerprint module (41 and 80) is further operable to transform each control fingerprint images (CFI) into a transformed control fingerprint image (TCF1) as a function of a pressure map (PM) associated with the user fingerprint image (UFI);
wherein the fingerprint module (41 and 80) is further operable to match each transformed control fingerprint image (TCFI) to the user fingerprint image (UF1); and
wherein the fingerprint module (41 and 80) is further operable to authenticate a first transformed control fingerprint image (TCFI) having a best match with the user fingerprint image (UFI) as an identified fingerprint image (IFI).

14. The fingerprint authentication system of claim 13, wherein the fingerprint module (41 and 80) is further operable to derive the user fingerprint image (UFI) from the pressure map (PM), wherein the user fingerprint image (UFI) is a black and white fingerprint image.

15. The fingerprint authentication system of claim 13, wherein the fingerprint module (41 and 80) is further operable to derive the user fingerprint image (UFI) from the pressure map (PM), wherein the user fingerprint image (UFI) is a grayscale fingerprint image.

16. The fingerprint authentication system of claim 13, wherein, during the transforming of each two control fingerprint image (CFI) into a transformed control fingerprint image (TC1) as a function of the pressure map (PM) associated with the user fingerprint image (UFI), the fingerprint module (41 and 80) is further operable to compute at least one control point within a first control fingerprint image (CFI) to yield a control point fingerprint image (CPFI), to superimpose the at least one control point onto the pressure map (PM), and to compute pixel intensities and directions around a neighborhood of the at least one control point from the pressure map.

17. The fingerprint identification system of claim 16, during the transforming of each two control fingerprint image (CFI) into a transformed control fingerprint image (TC1) as a function of the pressure map (PM) associated with the user fingerprint image (UFI), the fingerprint module (41 and 80) further operable to map the pixel intensities and corresponding control point distances for matching, to a greatest extent possible, the first control fingerprint image (CF1) into the user fingerprint image (UFI), and to warp the first control fingerprint image (CF1) based on the mapped pixel intensities and control point distances to thereby yield the first transformed control fingerprint image (TCFI).

18. The fingerprint authentication system of claim 13, wherein, during the transforming of each two control fingerprint image (CFI) into a transformed control fingerprint image (TC1) as a function of the pressure map (PM) associated with the user fingerprint image (UFI), the fingerprint module (41 and 80) further operable to compute at least one control point within a first control fingerprint image (CFI) to yield a control point fingerprint image (CPFI), to superimpose the pressure map onto the at least one control point, and to compute pixel intensities and directions around a neighborhood of the at least one control point from the pressure map.

19. The fingerprint identification system of claim 18, during the transforming of each two control fingerprint image (CFI) into a transformed control fingerprint image (TC1) as a function of the pressure map (PM) associated with the user fingerprint image (UFI), the fingerprint module (41 and 80) further operable to map the pixel intensities and corresponding control point distances for matching, to a greatest extent possible, the first control fingerprint image (CF1) into the user fingerprint image (UFI), and to warp the first control fingerprint image (CF1) based on the mapped pixel intensities and control point distances to thereby yield the first transformed control fingerprint image (TCFI).

20. The fingerprint identification system of claim 13, wherein, during the matching of each transformed control fingerprint image (TCFI) to the user fingerprint image (UF1), the fingerprint module (41 and 80) further operable to compute a matching score of each transformed control fingerprint image (TCFI) to the user fingerprint image (UF1).

21. The fingerprint identification system of claim 13, wherein, during the authenticating of the first transformed control fingerprint image (TCFI) having the best match with the user fingerprint image (UFI) as an identified fingerprint image (IFI), the fingerprint module (41 and 80) is further operable to select the first transformed control fingerprint image (TCFI) based on the first transformed control fingerprint image (TCFI) having a highest matching score among all of the matching scores.
